(19) United States
(12) Patent Application Publication
(10) Pub. No.: US 2019/0060788 A1
(43) Pub. Date: Feb. 28, 2019

(54) WEDGE SHAPED FILTERS, ASSEMBLY AND METHOD FOR FILTRATION AND COALESCING

(71) Applicant: FILTRATION TECHNOLOGY CORPORATION, Houston, TX (US)

(72) Inventors: John HAMPTON, Houston, TX (US); Greg WALLACE, Houston, TX (US)

(21) Appl. No.: 16/112,023

(22) Filed: Aug. 24, 2018

Related U.S. Application Data
(60) Provisional application No. 62/550,096, filed on Aug. 25, 2017.

(51) Int. Cl. B01D 19/00; B01D 27/14; B01D 27/06; B01D 29/54; B01D 29/13

(52) U.S. Cl. CPC B01D 19/0031; B01D 27/144; B01D 27/06; B01D 2201/605; B01D 29/13; B01D 2201/607; B01D 29/54

(57) ABSTRACT

A wedge shaped filter element for use with a variety of fluids and fluid mixtures is disclosed. Greater in filtration efficiency is provided due to increased filter media and compact arrangement that can be provided with a plurality of filter elements in filter housing. The wedge shaped filter elements can be used for filtration, coalescing fluids and separation of gas from liquid.

### PRIOR RELATED APPLICATIONS

This application claims priority to U.S. provisional application Ser. No. 62/550,096 filed Aug. 25, 2017, which is incorporated herein in its entirety for all purposes.

### FEDERALLY SPONSORED RESEARCH STATEMENT

Not applicable.

### FIELD OF THE DISCLOSURE

The disclosure generally relates to wedge shaped filters, the assembly of wedge shaped filters in a filter housing and method for filtering and coalescing liquids and gas and methods therefor. The wedge shaped filter media may be pleated media therein that are capable of high efficiency filtration as well as easy replacement of the filter element. The wedge shaped filters can be used to filter many types of fluids and fluid mixtures.

### BACKGROUND OF THE DISCLOSURE

Industrial filtration systems generally comprise one or more cylindrical cartridge filters located within corresponding filter housings, and fluids to be filtered (influents) are introduced into the cylindrical filter housings and subsequently into the cylindrical filter elements for the removal of debris, contaminants and particles. These cylindrical filter elements generally have a cylindrical hollow core. Influents flow into to the cylindrical filter element in one of two ways: either to the hollow core and flowing outwards through the media of the cylindrical filter element and exiting the cylindrical filter element (inside to outside flow) or the influent flows from the outside of the cylindrical filter element into a hollow core and then exiting the cylindrical filter element from the core (outside to inside flow), leaving debris, contaminants and particles at the surface of the media and the filtered fluid (effluents) exit the cylindrical filter housing. The cylindrical filter element, while easy to manufacture and use, do not effectively utilize the total space inside the filter housings that contain more than one cylindrical filter element. Unused dead space within the cylindrical filter housing results in less filter media surface area available in the cylindrical filter housing. The effect of the filter media surface area on the filtration cost and efficiency can be significant. Under more optimum conditions, doubling the filter media surface area can result in increasing the dirt holding capacity of the typical filter element by a factor of four (4) which greatly reduces filtration costs and time.

Therefore, there is a need for a new filter element and corresponding filter configuration to increase the volume of fluid that can be filtered in the same size filter housing, or provide a filter system that can filter the same volume of fluid or even more in a smaller housing. The new assembly can be installed in the commonly used cylindrical filter housing, but can be used with filter housings of different shapes that will accommodate a wedge filter such as a square or wedge filter housing. A new assembly and method can be used for liquid/gas separation and liquid/liquid separation in a coalescing process as well as filtration.

### SUMMARY OF THE DISCLOSURE

This disclosure is for a three dimensional wedge shaped filter element or coalescer element, an assembly with a plurality of wedge shaped filters and methods of filtration using a plurality of wedge shaped filters. The filter element is generally comprised of a wedge shaped top cap, a wedge shaped bottom cap, and pleated filter media extending between the top cap and the bottom cap. The filter media can be a single sheet of filter media folded into pleats, providing a central void inside the pleats for the filtered fluid. The pleated filter media extends from the wedged shaped top cap to the wedge shaped bottom cap. Both caps have side edges the approximate same length and shorter end and longer end to form a wedge. Two rows of pleats gradually decreasing in size from larger to smaller pleats extends from the longer end of the wedge to the smaller end of the wedge with at least one layer of media connecting the outer most largest pleats and the smallest inner pleats providing continuous layer of media forming a central void inside the pleats which can be wedge, triangular or round depending on the pleat configuration. The pleated filter media can be a single sheet of filter folded into pleats, providing a central void inside the pleats. The pleated media can have multiple layers of the same or different materials depending on the desired filter. In some embodiments, the media does not need to be pleated and can be solid media. The bottom cap has a central outlet communicating with the central void created by the pleated media through which the effluent or clean fluid passes. A filter support can also be provided inside the void, extending also from the top cap to the bottom cap to maintain the longitudinal integrity of the filter elements. The filter support is perforated to allow fluid flow inside the void created by the pleated media. The top cap also may have has a handle for easier insertion/removal of individual filter elements. In some embodiments, the wedge shaped filter element may have openings in the top and/or bottom cap. A separate cover for the top opening or hold down mechanism is provided to seal off the opening in the top of the filter.

In another embodiment of the wedge shaped filter is adapted for inside to outside out flow and one of the caps has an opening to receive influent while the other cap is solid. The influent flows from the central void through the pleated filter media so the effluent is collected outside the wedge shaped filter.

This disclosure also includes the filter assembly utilizing the wedge shaped filter elements. In one embodiment for outside to inside flow, the system uses a plurality of the wedge shaped filter elements are arranged in generally circular manner inside a generally cylindrical filter housing with space for fluid flow in between the filter elements, wherein the filter housing has fluid inlet for fluid to pass into the media of the plurality of wedge shaped filter elements. A generally circular separation plate inside the filter housing supports the wedge shaped filter elements. A central core may extend from the top of the filter housing to the separation plate of the filter housing surrounded by the inner sides of the wedge shaped filter elements. The bottom plate has a plurality of openings that communicate with and match the outlet on the bottom cap of each of the wedge shaped filter element to receive the clean fluid.

The increased area of fluid openings in the bottom or separation plate attributed to the wedge shaped filter element effluent openings reduces the pressure drop across the filter, therefore also increasing the filter efficiency. As well known in the field, excessive pressure drop adversely affect the filter's performance. Therefore, by increasing the flow-through area on the separation plate, it is possible to achieve more optimal level of pressure drop for better filter performance.

An outlet in the filter housing is located below the separation plate in the filter housing for receiving the filtered fluid. The wedge shape filter elements are spaced inside the filter housing to allow fluid flow around the wedge shaped filter elements.

For inside to outside flow a similar configuration of the wedge shaped filters is used. An inlet for influent is provided in one of the caps and the other cap is solid. In one embodiment, the filters are mounted under a separation plate inside the cylindrical filter vessel with the opening in the cap communicating with the corresponding openings in the separation plate. Influent enters the vessel above the separation plate and flows thought the opening into the void surrounded by the pleated filter media in each of a plurality of wedge shaped filter elements. The effluent or clean fluid exits the filter media under the separation plate into a chamber and is collected via an outlet in the filter vessel.

The wedge shaped filter can also be used in other configurations to separate gas and liquid mixtures. A cylindrical housing has an inlet near the bottom for the entry of a mixture of the gas and liquid. The housing has a separation plate sealably mounted to the circular inside wall of the housing. There are openings in the separation plate that communicate with a plurality of hollow risers that can be wedge shaped and arranged in a circular manner and are mounted on top of the separation plate. A plurality of wedge shaped coalescer elements are mounted on the top of the hollow risers and have a central void open in the bottom cap and a solid top cap. The gas/liquid mixture enters through the housing, through the openings in the separation plate, through the hollow riser and into the coalescing media through the void. The gas then rises to the top of the housing and is collected through an outlet. The liquid remains in the housing above the separation plate and can be drained or collected as desired. This disclosure also includes the method of gas/liquid separation described herein.

A further embodiment of the invention is a filter assembly that can be operated with a long axis of a housing placed horizontally to separate a mixture of heavy and light fluids assisted by gravity. A fluid inlet located on cylindrical housing with a circular separation plate sealably secured to the inner circumference of the housing. A plurality of wedge shaped coalescers are mounted in a circular manner on the separation plate and enclosed in the housing. Each of the wedge shaped coalescers has a cap with an opening communicating with a central void surrounded by media. The cap is mounted on the separation plate that has openings in communication with the cap openings and further in communication with the void in the filter media. A solid cap is on the opposite end of the wedge shaped filter from the end mounted in separation plate. The fluid to be separated passes through the openings in the separation plate and the cap of the coalescer element mounted thereon into the central void of the wedge shaped filters. The fluid mixture then passes through the media. The fluid mixture is collected in the filter housing on the side opposite the separation plate from the inlet. The lighter fluid floats to the top of the filter housing and the heavier fluid settles to the bottom of the filter housing. The filter housing is provided with an outlet on the top to collect the lighter fluid and an outlet on the bottom to collect the heavier fluid. Another related embodiment utilizes a vertical housing with risers similar to the gas/liquid separation design discussed above. The lighter liquid is collated at the top of the housing, while the heavier liquid settles around the risers above the separation plate and is collected. This invention also includes the method of liquid/liquid separation described herein.

A further embodiment of the invention is a method for filtering fluid. The fluid to be filtered is introduced into cylindrical filter housing with a plurality of wedge shaped filters having top cap and bottom caps with filter media extending from the wedged shaped top cap to the wedge shaped bottom cap with media extending from the top cap to the bottom cap and surrounding a central solid core arranged in circular manner inside the housing. The fluid passes through at least one layer of media and enters the void in the center of the wedge shaped filters wherein said void is closed at the top and bottom by the top cap and bottom cap. The bottom cap has an outlet for the filtered fluid. The filtered fluid is collected from the outlets on the bottom caps of the plurality of wedge shaped filters.

Alternatively, the fluid introduced into the filter housing can be introduced into a central void located in each of the wedge shaped filters and further passed through at least one layer of media surrounding the void. The fluid is collected in a separate chamber of the filter housing and removed.

### DEFINITIONS

As used herein, “influent” or “dirty fluid” means the fluid to be introduced to and filtered by the filter.

As used herein “inside to outside flow” means fluid flowing from the inside of a filter to the outside of the filter and can be used interchangeably with “inside to out” or “inside out”.

As used herein “outside to inside flow” means fluid flowing from the outside of a filter to the inside and can be used interchangeably with “outside to in”.

As used herein, “effluent” or “clean fluid” means the clean filtered fluid already passing through the filter media.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

### BRIEF DESCRIPTION OF THE DRAWINGS

FIG. 1A is a schematic perspective view of a wedge shaped filter element of this disclosure mounted on the separation plate.

FIG. 1B is a cut away cross section of the wedge shaped filter element wherein the filter media is cut out to reveal the perforated support.

FIG. 1C is a side view of a wedge shaped filter element showing the top cap and the bottom cap with the attachment to the separation plate.

FIG. 2A is a cross-sectional view of a wedge shaped filter element and bottom cap with pleated filter shown as it sets in the cap.

FIG. 2B is a bottom view of a bottom cap of a wedge shaped filter element of this disclosure.

FIG. 2C is a partial vertical cross-sectional view near the bottom cap of the wedge shaped filter element of this disclosure

FIG. 3 is a bottom view of a separation plate of this disclosure.

FIG. 4A is a schematic illustration of the outside to inside filtration process with a cut away view of one of the wedge shaped filter elements.

FIG. 4B is a cross section of a wedge shaped filter element illustrating outside to inside flow.

FIG. 5 is a schematic view of a filter assembly for outside to inside flow direction with a partial assembly of the wedge shaped filter elements elevated to show the supports.

FIG. 6A is a schematic illustration of outside to inside flow showing the cylindrical filter vessel with the wedge shaped filter elements elevated to show the supports.

FIG. 6B is a cross section view of the vessel and wedge shaped filter elements for outside to inside flow.

FIG. 7A is a schematic illustration of inside to outside flow showing the cylindrical filter vessel with the wedge shaped filter elements with openings in the top caps.

FIG. 7B is a cross section view of the vessel and wedge shaped filter elements for inside to outside flow.

FIG. 8 is a schematic view of a gas-liquid separation assembly with wedge shaped filter elements.

FIG. 9A is an alternative embodiment of the disclosure with a spider plate shown that can be used with a swimming pool or spa filter housing.

FIG. 9B detail of the spider plate and wedge shaped filter elements with a spring for use in closure of plate.

FIG. 9C is a further detail of the insertion point of the wedge shaped filter element into the filter receiver.

FIG. 10 is a schematic view of the wedge shaped filter elements used for a coalescer to separate liquids with different specific gravities.

FIG. 11 is a view of the use of wedge shaped filter elements for separation of gas from liquid.

FIG. 12 is an alternative embodiment of the disclosure showing multiple rows of wedge shaped filter elements.

FIGS. 13A and 13B are views comparing the use of cylindrical filters and wedge shaped filter elements in an 18 inch diameter vessel.

FIGS. 14A and 14B are views comparing the use of cylindrical filters and wedge shaped filter elements in a 24 inch diameter vessel.

### DETAILED DESCRIPTION

The present disclosure describes a novel wedge shaped filter element, comprising a solid top cap generally wedge shaped that can have curved outer and inner sides to accommodate placement in a generally cylindrical filter housing; a bottom cap with an outlet therein, said solid bottom cap having a generally wedge shaped with curved outer and inner sides; and pleated filter media extending from the wedged shaped top cap to the wedge shaped bottom cap with two rows of pleats gradually decreasing in size from larger to smaller pleats from the outer side of the wedge to the smaller inner side of the wedge with a layer of media connecting the outer most largest pleats to the smallest inner pleats. This arrangement is used for outside to inside flow.

In another aspect of this disclosure is a filter assembly using a plurality of three-dimensional wedge shaped filter elements for inside to outside flow, outside to inside flow, and/or separation of fluids. An assembly of wedge shaped filter elements may be used for separation and filtration of liquids and gases or as coalescers for separation of the two liquids with different specific gravities.

This disclosure also includes methods for use of the wedge shaped filter elements for filtration of fluids as well as separation of fluids.

From here on, detailed explanation of the wedge shaped filter element, assemblies thereof and method of this invention may be made with reference to the drawings. The number and size of the wedge shaped filter elements can be varied according to the size of filter vessel, type of filtration and/or coalescing or any other variable that needs to be addressed in processing the fluid or fluid mixture. The following examples are intended to be illustrative only, and not unduly limit the scope of the appended claims.

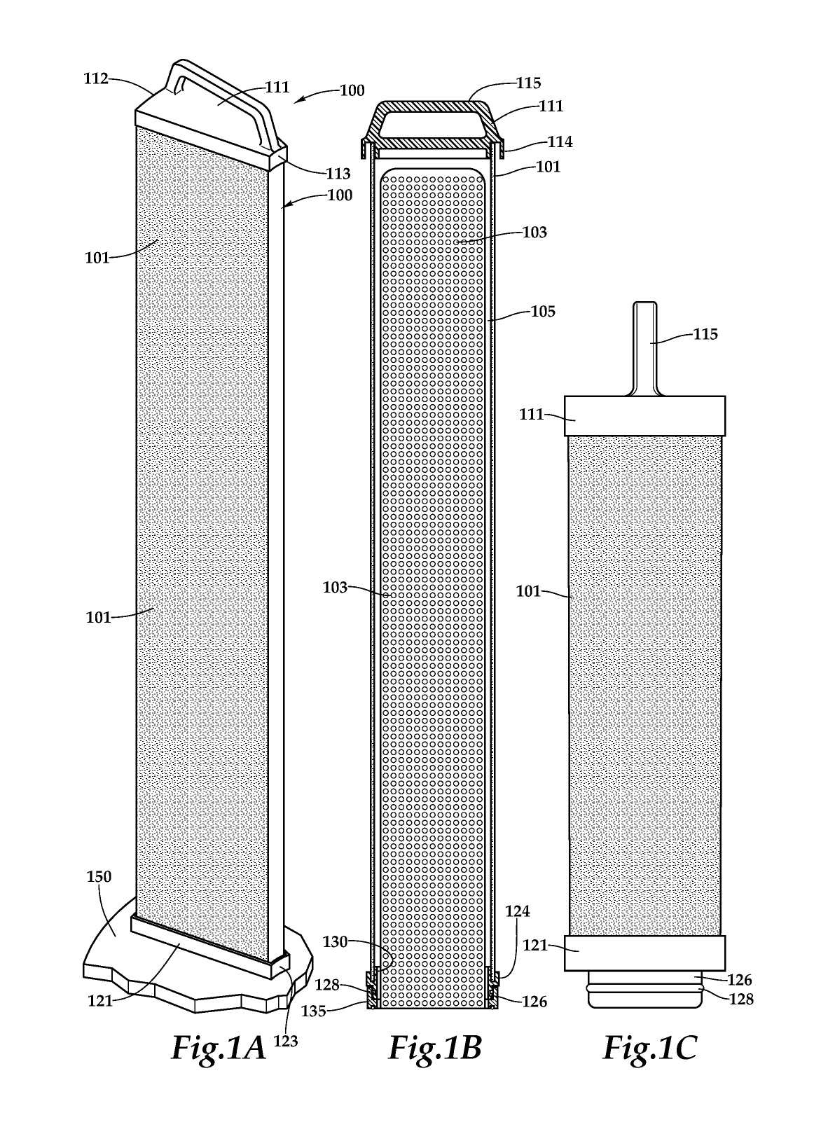

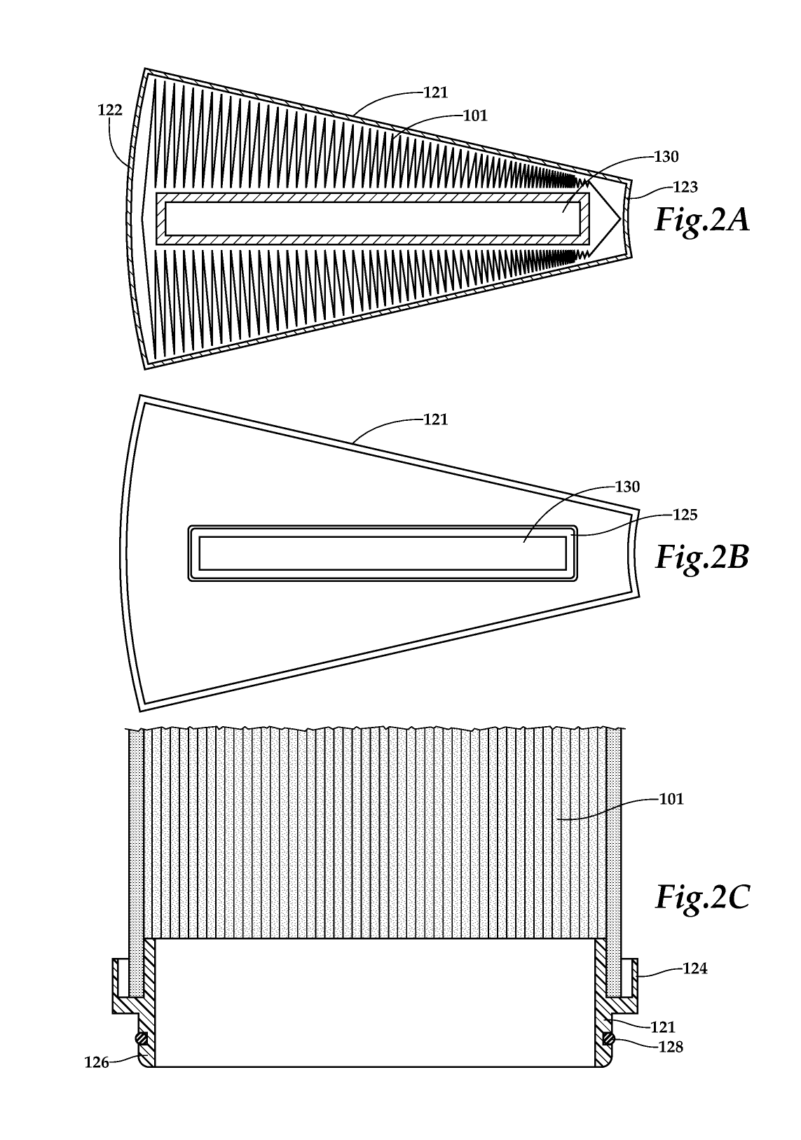

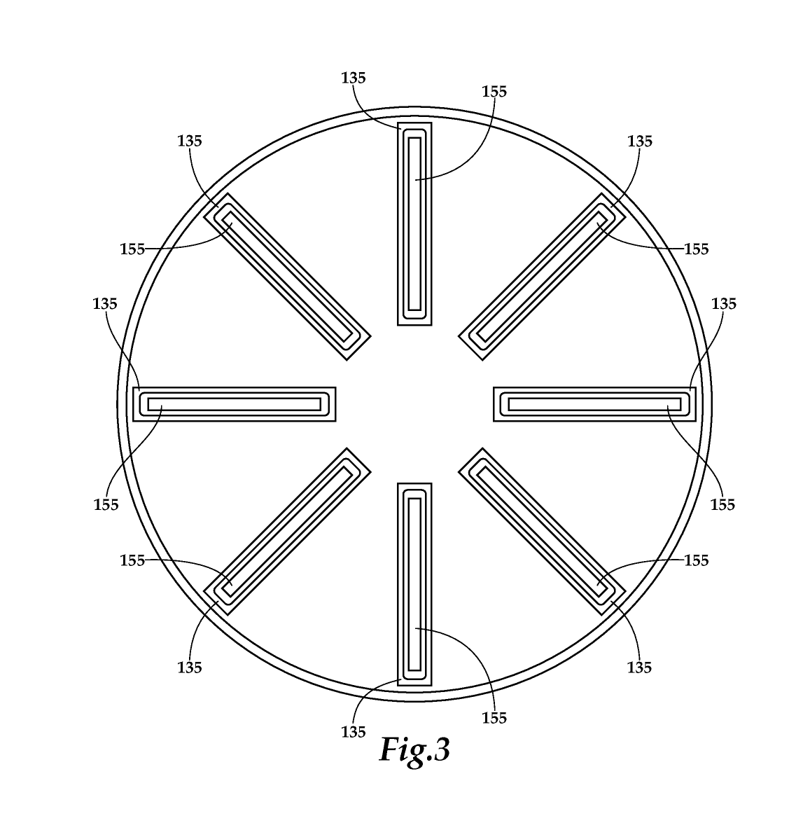

The following description is for the use of the wedge shaped filter element for outside in flow. Please refer to FIG. 1A which shows a perspective view of the wedged shape filter element 100 of this disclosure. As seen in FIG. 1A, the wedge shaped filter element 100 is generally comprised of a top cap 111 (shown in this view with a handle 115), a bottom cap 121, and the filter media 101 that may be pleated and extends from the top cap 111 to the bottom cap 121. The top and bottom caps may have curved outer edges 112 and 122 as shown in FIGS. 2A and 2B and shorter curved inner edges 113 and 123 respectively. In FIG. 1A part of the separation plate 150 is generally shown that is located inside the filter vessel on which the wedge shaped filter element 100 is mounted is shown and will be discussed in further detail below.

The filter or coalescing media material is not limited and can be customized depending on the type of filtration or coalescing. The media may be pleated media of cellulose and other natural media or synthetic media including but not limited to polypropylene, polyester, nylon, PTFE, PPS, ECTFE and PVDF. The pleated media may be one layer of material or multiple layers of different materials depending on the needs for filtration or separation. Other types of media including non-pleated depth media polypropylene, polyester, nylon, PTFE, PPS, PVDF, ECTFE, cellulose fiber, glass fiber, and woven wire mesh and ceramic media could be used. The filter may be single use and disposable or reusable after cleaning. This invention is not limited to any type of media used in the wedge shaped filters or coalescers.

Referring now to FIG. 1B, which is a side view of the wedge shaped filter element of this disclosure, part of the pleated filter media is cut out to view the perforated support 103. The perforated support 103 is secured to and extends upwardly from and is secured to a separation plate 150 (not shown) in the filter vessel. As discussed with regard to FIG. 2A below, the pleated filter media has a void 105 in the middle where this perforated support 103 is located for both maintaining the physical integrity of the filter element, as well as providing flow path for the filtered fluid within the void in the filter media. The perforated support 103 can be made of any rigid and light material to support the overall weight and pressure within the pleated filter media.

A plurality of perforated supports is provided in the filter vessel to correspond with the number of wedge shaped filter elements utilized. One layer of pleated media 101 is shown in the cross section that is part of the continuous pleated media surrounding the perforated support 103. The perforated support 103 extends through an opening in the bottom cap 130 and extends through the void 105 shown in FIG. 1B. The perforated support 103 is located in void 105 for both maintaining the physical integrity of the filter element, as well as providing flow path for the filtered fluid. The perforated support 103 can be made of any rigid and light material to support the overall weight and pressure within the pleated filter media. Non-limiting examples include plastic, reinforced plastic, ceramics and metals.

The bottom cap 121 is shown in cross section and has an outer lip 124 that extends upward to enclose the bottom edge of the pleated media 101. The top cap 111 also has an outer lip 114 that extends downward and encloses the upper edge of the pleated media 101. The ends of the filter media abuts the inside of each of the caps and is secured with an adhesive, potting resin or compounds or any other type of bonding known to those skilled in the art. FIGS. 1B and 1C show bottom cap 121 that includes an outlet connector 126 with O-ring 128. The outlet connector 126 that extends from bottom cap 121 is sealably received and secured in filter receiver 130 that is shown as a wedge shaped lip extending upwardly from the separation plate 150. When the wedge shaped filter element is placed over the perforated support 103, the end cap 121 is secured on the separation plate via the O-ring 128 into the filter receiver 135 enabling the effluent can flow from the void 105 through the opening in the separation plate. Other secure attachments can be used as well.

FIG. 2A is a horizontal cross section near the bottom of the wedge shaped filter element showing the pleated filter media 101 with the pleat size that increases in width toward the longer end of the wedge shaped filter element to increase filtration area and filtration capacity. In this cross-section, it can be seen that the pleated filter media 101 can be one or more sheets of filter media folded continuously around the center forming an central inside void 105, into which the filtered fluid flows from outside to inside flow, and the fluid and remains inside the void 105 before exiting the filter element through an opening 130 in the bottom cap 121. The pleated media extends from the wedged shaped top cap to the wedge shaped bottom cap with two rows of pleats gradually decreasing in size from larger to smaller pleats from the outer side of the wedge to the smaller inner side of the wedge with a layer of media connecting the outer most largest pleats to the smallest inner pleats providing a generally central void inside the pleats. The pleated filter media 101 is pleated around and continuously surrounds the void 105 in the middle of the pleated media to allow the influent to flow through the pleated media into the void and flow out opening 130 located on the bottom cap 121. Solid media in a similar configuration may be used.

Referring now to FIG. 2B, which shows a perspective view of the inside of the bottom cap 121 and the opening 130 without media. The bottom cap has an inner lip 125 defining the opening 130 that the media surrounds. The top cap 111 and bottom cap 121 maintains the wedge shape of the filter element. The ends of the filter media abuts the inside of each of the caps and is secured with an adhesive, potting resin or compounds or any other type of bonding known to those skilled in the art.

Referring to FIG. 2C, shows a partial cross section view of the bottom section of a wedge shaped filter element of this disclosure. This figure illustrates how the pleated filter media 101 interfaces with the bottom cap 121. Lip 124 is provided on the bottom cap to enclose the outer bottom edge of the media. The outlet connector 126 is shown extending from the bottom cap. O-ring 128 is provided on the outer circumference of the outlet connector 126 that is used to secure the wedge shaped filter in place in the filter receiver 135 mounted on separation plate 150 (not shown).

FIG. 3 is a top perspective view illustration of the separation plate 150 that is securely mounted inside a filter vessel with eight (8) filter receivers that sealably receive the outlet connectors 126 on the bottom caps of each of eight (8) wedge shaped filter elements. There are eight (8) filter receivers that also define outlet ports 155 for each of the openings 130 in the bottom caps for the wedge shaped filter elements. FIG. 3 shows a view of the bottom or separation plate 150 that is sealably secured and positioned at the bottom of a generally cylindrical filter housing on which the perforated supports 103 are mounted. The perforated supports 103 are attached to the separation plate 150 so the exits for the effluent, outlet ports 155, are not blocked. The separation plate 150 should completely seal off any leakage, allowing the filtered fluid to exit the filter housing only through the outlet ports 155. The outlet ports 155 are inside and surrounded by the filter receivers 135 to correspond to and match with the outlet connectors 126 on the bottom caps of the filter elements, so that the filtered fluid would only exit the voids through outlet connectors 126 on the bottom caps and the corresponding the outlet ports 155.

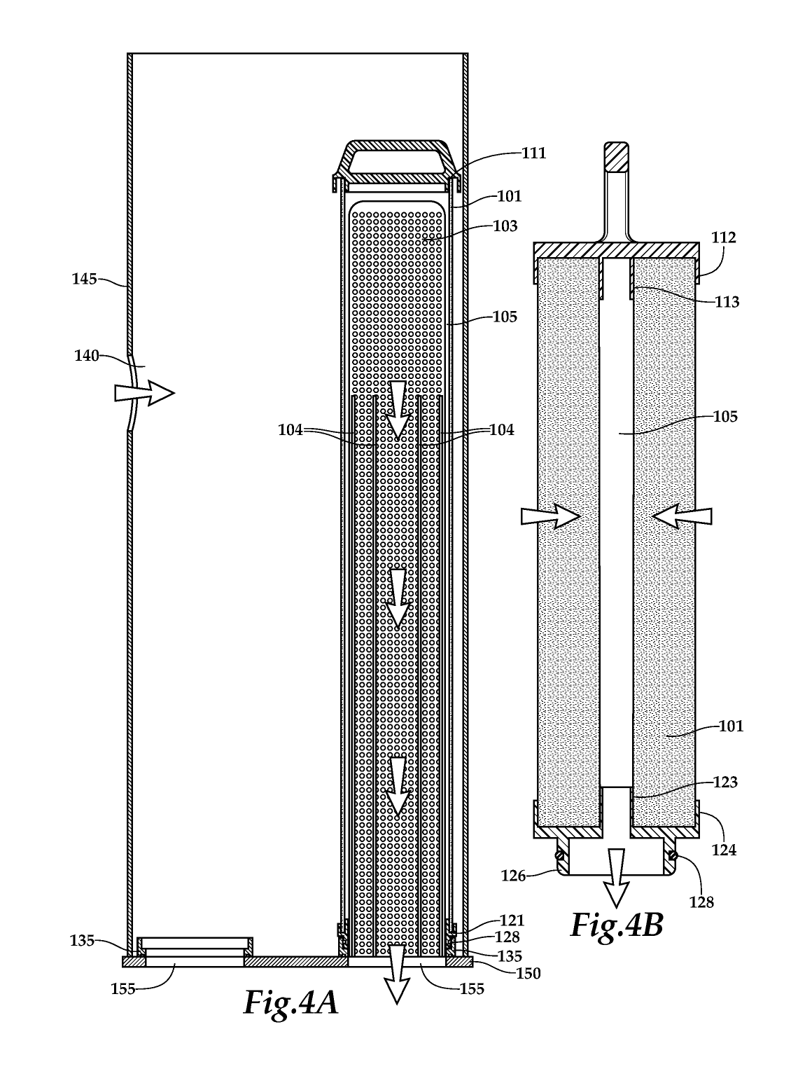

Refer now to FIG. 4A, which is an illustration of the outside to inside filtration flow using wedge shaped filter elements. The dirty fluid (influent) is introduced through a fluid inlet 140 of the filter vessel 145 in the vessel wall. The dirty fluid then flows through the filter media 101 of one of the wedge shaped filters, and the clean fluid flows through the central void 105 inside the filter media (indicated by the flow arrows in the drawing) which void 105 has the perforated support 103 inserted therein. The perforated supports 103 can be welded, bolted or attached to separation plate 150 as known to those skilled in the art. The perforated supports are places so they do not impede fluid flow in the void 105 or through outlet ports 155. If the separation plate 150 is made of plastics or fiber reinforced plastic, the perforated supports 103 can molded to the separation plate 150. The fluid then flows through the opening 130 in the bottom cap 121 that communicates with the filter receiver 135 mounted on separation plate 150. FIG. 4A also shows optional stiffeners 104 mounted on the bottom face of the filter receiver 135 to provide additional stability to the perforated support 103. The outlet connecter of the bottom cap of each of the wedge shaped filters is inserted into the upwardly projecting lips of the filter receivers 135 mounted on the top of separation plate 150. The O-ring 128 is used to provide a seal between the bottom cap and the wedge shaped filter to secure the filter in place with a tight connection. The opening in the bottom cap communicates with a corresponding outlet port 155 in the separation plate 150 thus providing fluid communication from the central void 105 with the filtered fluid through the separation plate to the chamber below in the filter housing.

FIG. 4A illustrates the filtration mechanism of this wedge shaped filter element. The influent or dirty fluid is introduced through a fluid inlet, typically from a side flange on the vessel wall. The dirty fluid then flows through a layer of the filter media on one of the filter elements that is shown with a perforated support 103 in this view, and the clean fluid flows through the opening in the through outlet connectors 126 on the bottom caps and the corresponding the outlet ports 155 in the separation plate 150 and the effluent exits the filter vessel.

FIG. 4B illustrates the filtration flow of the wedge shape filter. This is an outside to inside flow direction, where the filter opening 123 for the filtered fluid is located at the bottom cap 121 of the filter element 100. The fluid flows from outside of the filter media 101 to the center void 105, and eventually exits the wedge shaped filter 100 through the filter opening 123 in the bottom cap. The bottom cap outlet connector 128 is secured into the filter receiver 208 on the separation plate via the O-ring 128. Optionally, a gasket seal or a positive O-ring 128 can be provided on the bottom cap for a better seal between the bottom cap and the filter receiver 135 to avoid fluid bypass. Also, the O-ring or gasket seal can provide a resistance signal for the user that once the resistance is overcome, the element is properly installed in place.

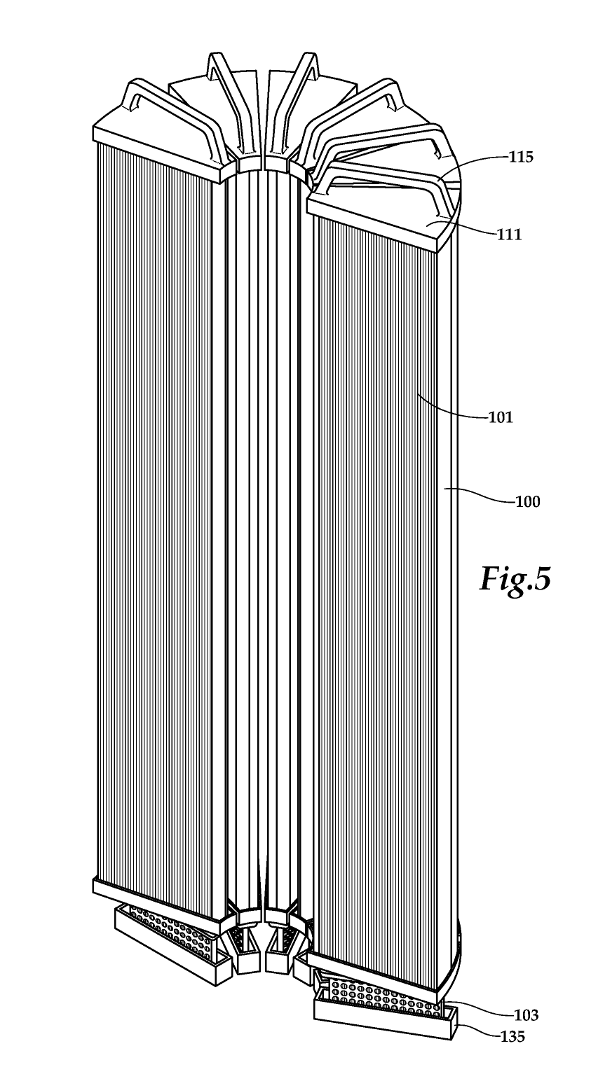

FIG. 5 shows an array of wedge shaped filter elements 100 as they would be placed inside a generally cylindrical filter vessel and mounted over the perforated supports. As shown in FIG. 2, the filter elements 100 are arranged in a pie-shaped manner and a central core can be provided. The horizontal diameter cross sectional perimeter of each filter element is designed so that the dead space containing filter media within the filter housing is kept to a minimum with the multiple wedge shaped filters. The space not occupied by the filter elements allows the dirty fluid to flow inside the housing, but does not create undesirable turbulent flow. This configuration also maximizes the filtration area provided by each wedge shape filter element with the novel configuration of pleated filter media.

Each filter element has a top cap 111, on top of which a handle 115 is provided for easier insertion/removal, especially when the filter segment has been in use for a long time and debris accumulates at the bottom of the filter housing. Without the handle 115 it can be more difficult to remove individual filter element 100. The wedge shaped filter elements are raised up in this view that illustrates the use of the handle. The raised wedge shaped filter elements in FIG. 5 illustrates the positioning of the perforated supports 103 that are mounted in the filter receivers 135 on a separation plate (not shown in this view).

There is space between each wedge shaped filter elements 100 to allow influent unfiltered fluid to flow through the filter media 101. The top caps 111 and bottom caps 121 do not block off any fluid from passing through the filter media 101, as there is adequate space between the filter media of the filter elements.

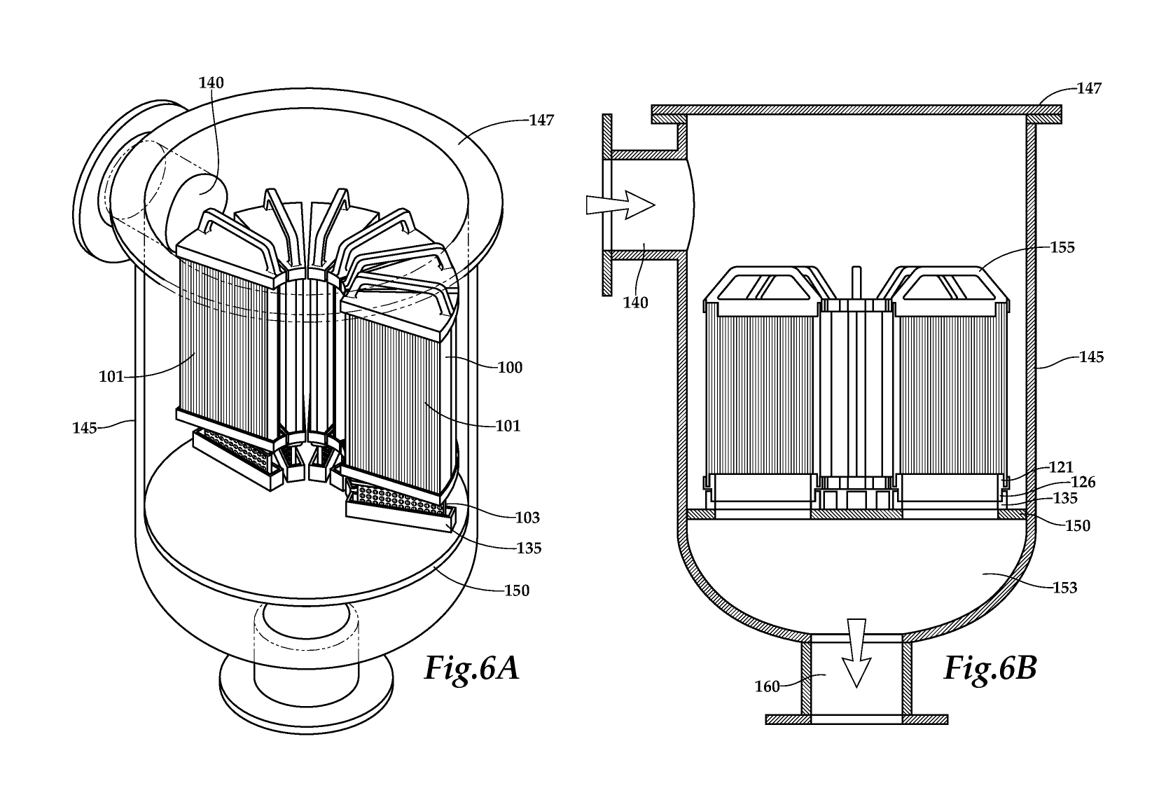

FIG. 6A is a schematic illustration of a configuration for outside to inside fluid flow and is also shown in FIG. 6B. In FIG. 6A for illustrative purposes about half of the wedge shaped filter elements that are in a pie shaped arrangement are shown. The number of filter elements 100 in this figure is only for illustrative purpose, and the actual number of filter elements 100 will depend on many factors, such as the size of the filter housing, the fluid flow rate, the particulates to be filtered, and the nature of the fluid. Also the wedge shaped filter elements are raised to show the perforated supports 103. The separation plate 150 has a plurality of filter receivers 135 to receive the outlet connectors 126 on the bottom caps with openings (not shown). Also, the perforated support 103 is mounted to and extending from the separation plate 150 and this configuration also facilitates installation and removal of individual filter elements 100 because the perforated support 103 also serves as a guide matching the central void of each wedge shaped filter element to properly mount the wedge shaped filter element on the separation plate 150.

FIG. 6B shows the lid 147 of the filter vessel 145 that is secured during the filtration process. The lid may be removed to replace and/or clean the wedge shaped filters aided by the use of a handle to place and remove the filters. At the start of filtration, the fluid to be filtered is introduced through the dirty fluid inlet 140 into an empty filter vessel, and then fills the filter vessel from the separation plate 150 upwards. When the fluid level reaches the filter media 101, the fluid flows across the filter media 101 and into the center void 105 of the filter elements. The filtered fluid that has passed through the filter media then flows through the outlet openings in the bottom caps of filter elements, through the corresponding openings in the filter receivers 135 and separation plate 150 into a chamber 153 below the separation plate 150 and eventually exiting the filter housing through the clean fluid outlet 160 at the bottom of the filter vessel.

In addition, the increased number of filtered fluid openings in the separation plate effectively reduces the pressure drop across the filter, therefore also increases the filter efficiency. As well known in the field, excessive pressure drop adversely affects a filter's performance. Therefore, by increasing the flow-through space on the separation plate, it is possible to achieve an optimal level of pressure drop for better filter performance.

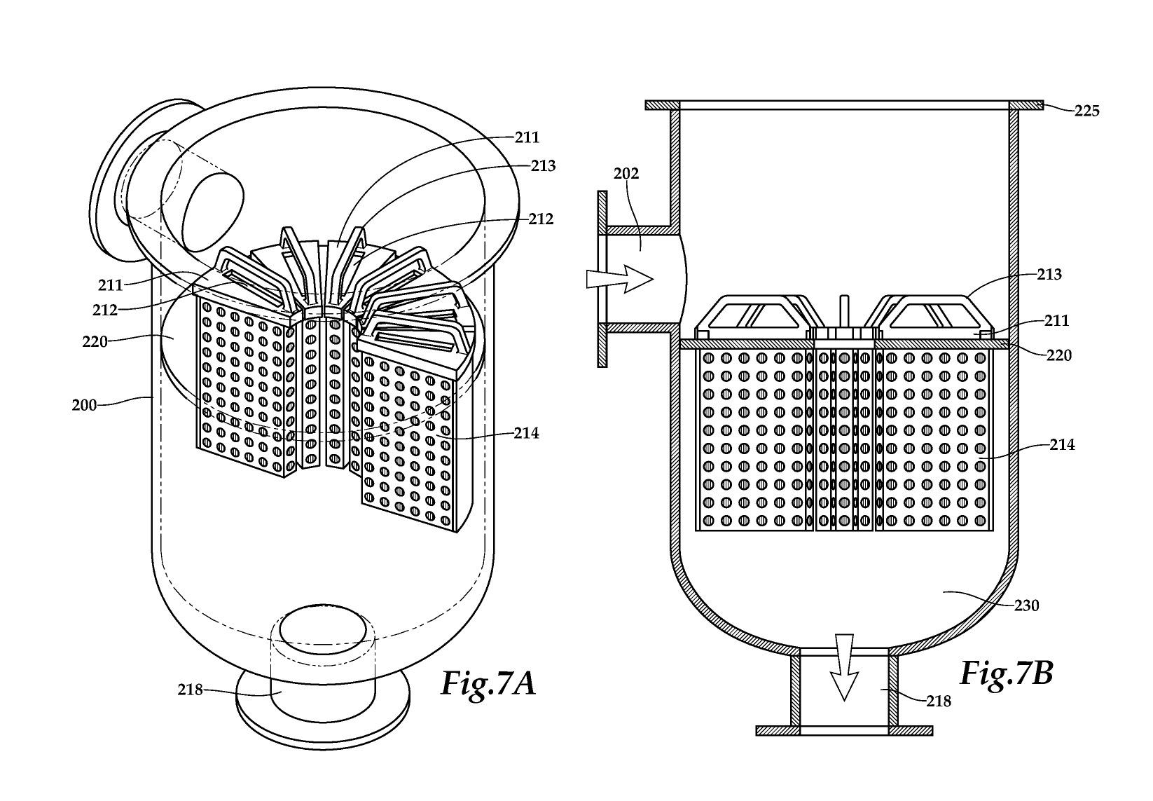

FIGS. 7A and 7B are schematics of reverse flow inside out utilizing the wedge shaped filter elements in filter vessel 200. The wedge shaped filter elements have top caps 211 shown with generally rectangular shaped openings 212 shown in FIG. 7A under the handle 213. The openings 212, which can be any configuration to allow fluid flow, communicate with the central void (not shown) that is formed by the filter media in the same manner as shown in prior FIG. 2A. Each wedge shaped filter element is inserted into the separation plate 220 such that the only entrance for the dirty fluid is through the openings 212 in each top cap 211. The separation plate 220 is placed toward the top of the filter vessel. Each wedge shaped filter element is sealably secured to the separation plate 220 by an O-ring or other means previously described in this disclosure. The pleated filter media is in the same configuration creating a central void for collection of dirty fluid entering the through the openings 212 in the top cap. In one embodiment shown in the FIGS. 7A and 7B, baskets 214 are placed under the separation plate to receive the wedge shaped filter element. The baskets may be permanently mounted or removable as desired. The baskets are made of perforated support material to maintain the integrity of the wedge shaped filter elements.

FIG. 7B is a drawing showing a cross section side view inside to outside reverse flow arrangement using the wedge shaped filter elements. The dirty fluid enters the cylindrical filter vessel 200 which is closed with vessel lid 225 through inlet 202 and passes through openings (not shown in this view) in the top caps 211 under the handles 213 into the void in the wedge shaped filter elements that are shown enclosed in the baskets 214. The separation plate 220 is shown with the baskets 214 mounted underneath, either permanently or removably. After the fluid passes through the pleated media, the clean fluid is collected in chamber 230 and exits the cylindrical filter housing through the clean fluid outlet 218.

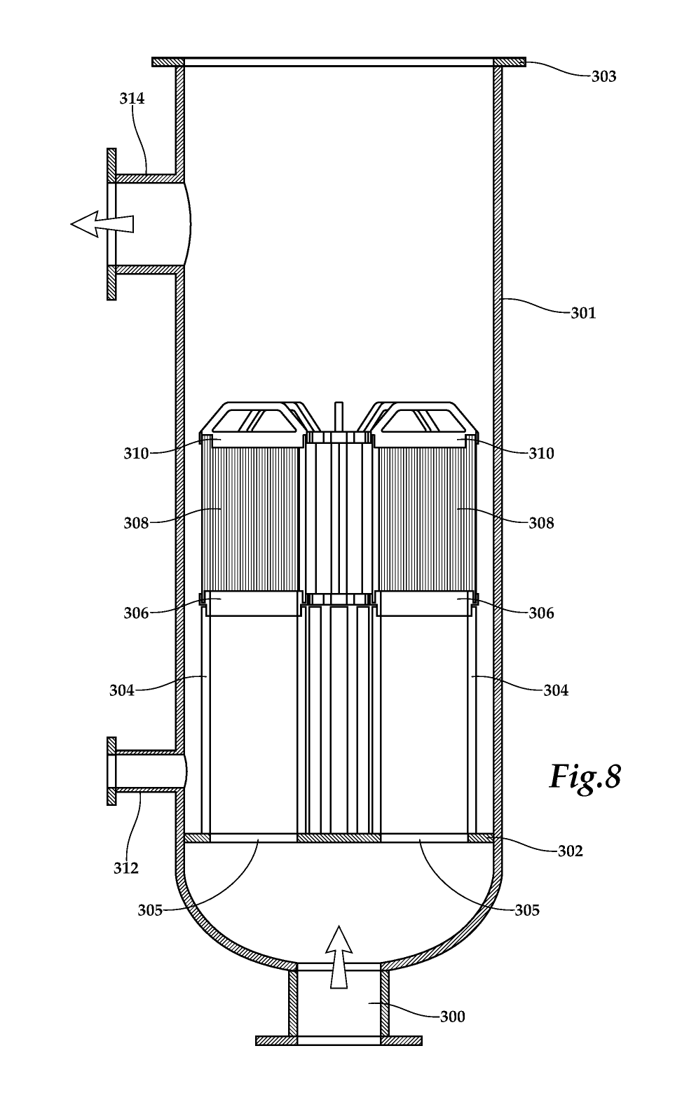

FIG. 8 is an adaptation of the use of the wedge shaped filter elements preferably for separation a mixture of fluids composed of liquid and gas through coalescence. The mixture is typically an aerosol. FIG. 8 shows generally cylindrical filter vessel 301 with lid 303. There is an inlet 300 at the bottom of the vessel to receive the mixture, but the inlet can also be on the side of the vessel 301 under the separation plate 302. A separation plate 302 is mounted securely and sealably toward the bottom of the generally cylindrical filter vessel 301. Hollow supports 304 are mounted on top of the separation plate 302 and there are openings 305 in the separation plate communicating with the hollow interior of the supports 304. The bottom caps 306 of the wedge shaped filter elements are sealably mounted as previously disclosed to the top of the risers 304. The dirty liquid and gas passes through the opening 305 in the separation plate 302, then rises through the hollow supports 304, though openings in the bottom caps 306. The top caps 310 are solid forcing the mixture through the pleated media 308 from the void inside trapping any particulate matter with the clean gas passing through the media. The flow in this embodiment is from the inside of the wedge shaped coalescer element to the outside. The liquid will fall to the bottom of the filter vessel 301 and the gas will rise to the top of the filter vessel 301. The hollow supports 304 provide an accumulation zone below the wedge shaped filter elements for the liquid that can be removed through liquid outlet 312. The gas that rises to the top of the filter vessel 301 is removed through the clean gas outlet 314. This configuration allows gas and liquid to separate by gravity.

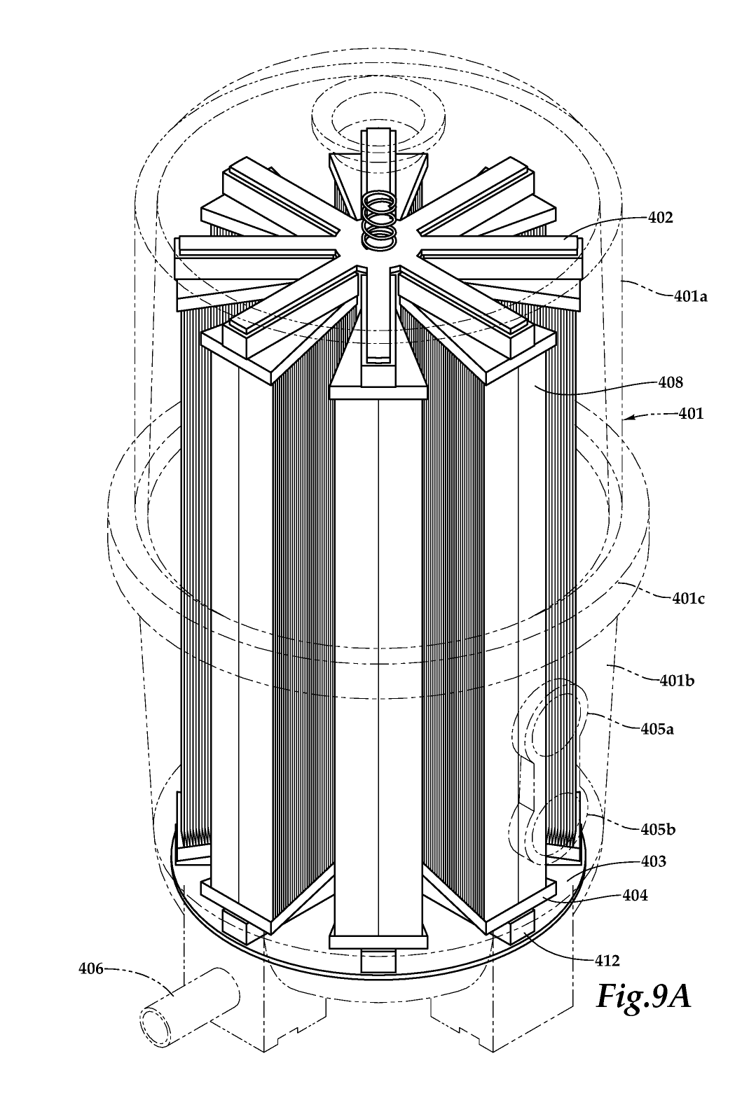

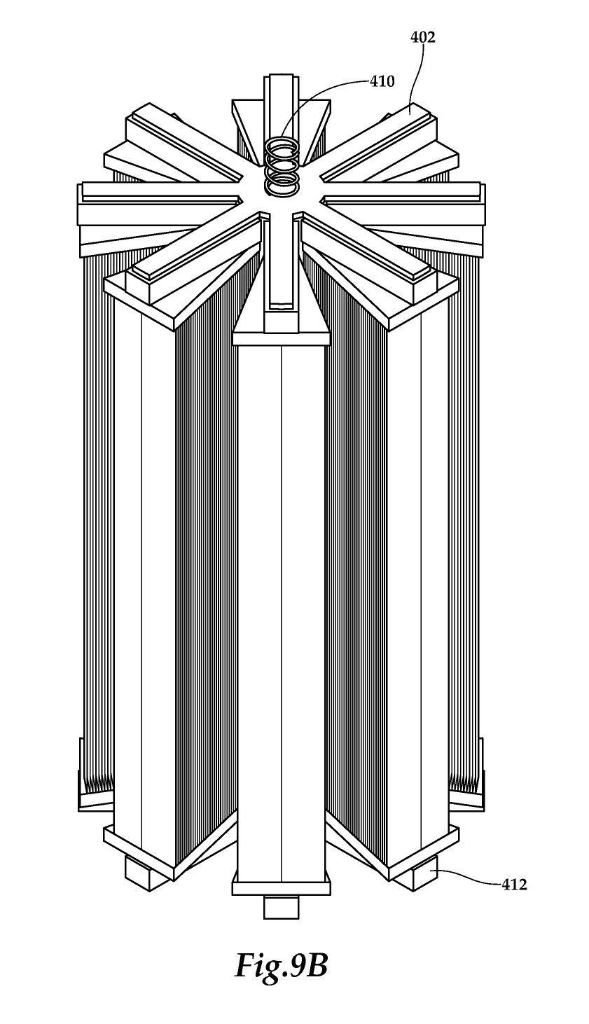

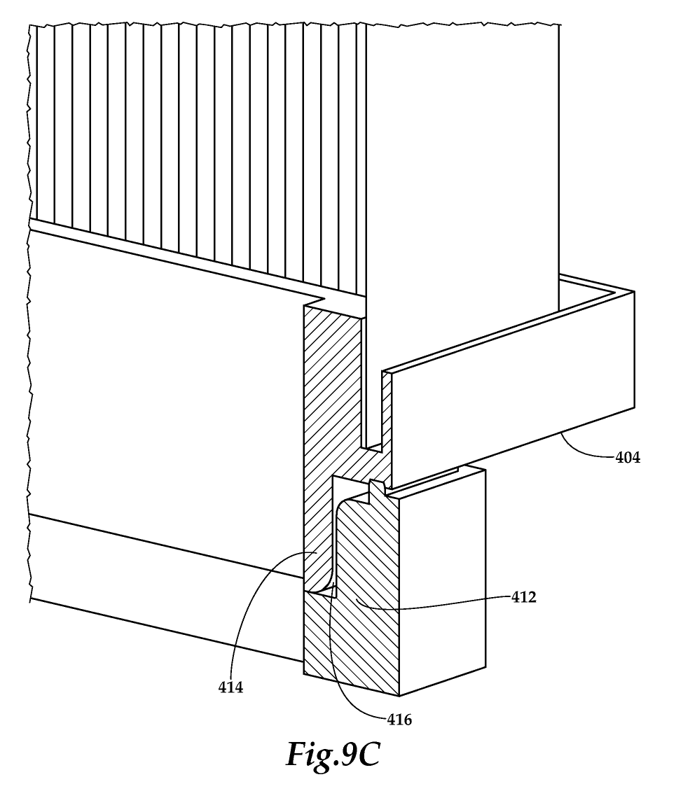

FIG. 9A is another embodiment of the outside in flow that can be adapted for uses including swimming pool filters and other applications. The filter housing 401 is shown with a series of wedge shaped filter elements (one of which is indicated at numeral 408) arranged under a spider plate 402. Instead of or in addition to the top caps for each of the wedge shaped filter elements, a single spider plate 402 is used. The spider plate 402 has a central hub with radiating arms that are securely placed over each of the wedge shaped filter elements inside filter housing. The fluid flow is outside to inside flow as previously described herein. Typically the filter housings for swimming pools are in two pieces with the top housing 401a and the bottom portion of the housing 401b that are secured together in a tight circumferential seal at 401c. The top housing 401a can be removed after the fluid is drained from the housing to access the filters. The fluid, which in the case of swimming pools would be water, enters typically through two inlets 405a and 405b located on the bottom portion of the housing 401b. The water flows through the wedge shaped filter elements from outside to inside and is collected in the central voids and the effluent or clean water flows though the fluid outlets of each wedge shaped filter element in the bottom cap, one of which is referenced as numeral 404, that are in communication with the internal void of the wedge shaped filter elements and also communicate through openings in the separation plate. The wedge shaped filter element bottom cap is inserted sealably into bottom cap receiver 412 on the separation plate 403. The clean filtered water accumulates under the separation plate 403 and exits the filter housing 401 through outlet 406.

FIG. 9B is a view of the wedge shaped filter elements and spider plate. The spider plate 402 can be secured in place with a spring 410 or other compression apparatus that is placed between the inside wall of the top filter housing 401a and the central hub of the spider plate 402 as shown in FIG. 8B. The spider plate 402 can be made of material that is soft and compressible such as polyurethane, platisol, silicone, epoxy or plastic with an elastomer that will maintain its integrity but is not brittle, so that when the top housing 401a is secured to the lower housing 401b, the tension maintains the wedge shaped filter element in place with the bottom cap outlets 412 are firmly inserted and held in the separation plate 403.

FIG. 9C is a close-up view of the preferred embodiment of the wedge shaped filter element bottom cap 404 inserted into the separation plate 403. The wedge shaped filter element bottom cap 404 terminates in a generally wedge knife edge protrusion 414 surrounding the effluent flow outlet from the central void of the wedge shaped filter element. The knife edge 414 is inserted into and held in place in generally wedge lip 416 that extend upward from bottom cap receiver 412 on the separation plate 403 that correspond to each wedge shaped filter element outlet. As shown in FIG. 9C, there is a tight fit with the insertion of the knife edge 414 and the lip 416. Further, when the when the top housing 401a is secured to the lower housing 401b, the force of the spring on the spider plate further secures the placement of the wedge shaped filter element in the separation plate.

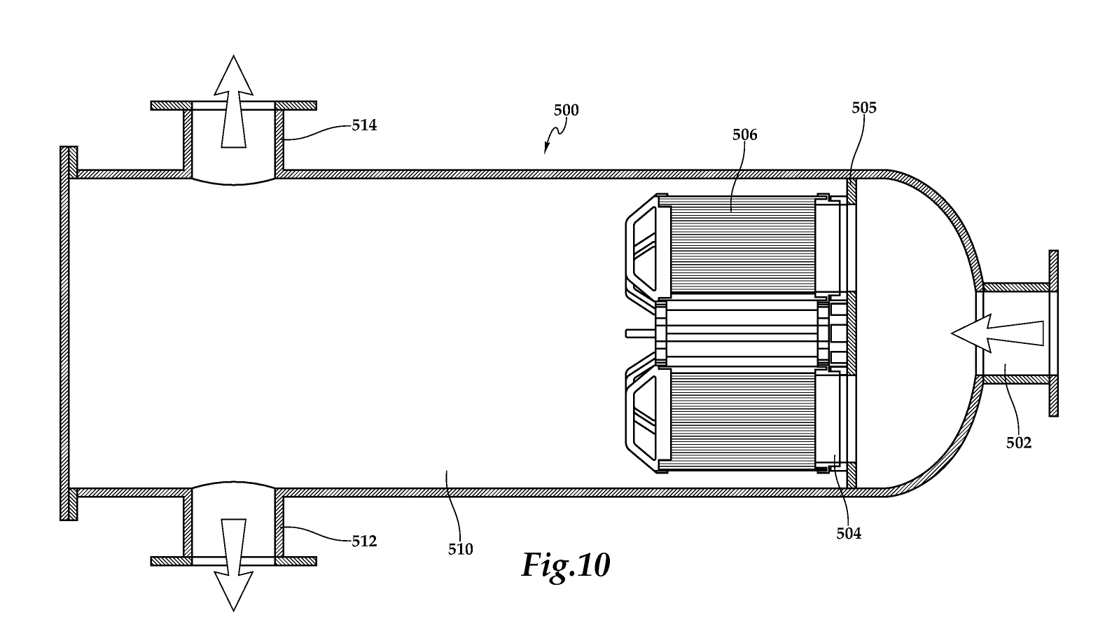

FIG. 10 is a view of the wedge shaped filter elements used as a coalescer for filtration and separation of liquids with two different specific gravities. The cylindrical filter housing 500 is placed horizontal instead of upright for this use. The mixture of two dirty fluids or influent enters the vessel at 502. The mixture flows through the hollow supports 504 (entrance inlets in hollow supports not shown in this view). The hollow supports 504 are mounted on separation plate 505 so the fluid can only enter through the inlets corresponding to the inlets of the supports. The liquid mixture then flows into the central void of the wedge shaped filter elements one of which is referenced at numeral 506. The filtered and coalesced liquids then flow through the pleated media of the wedge shaped filter element 506 into the chamber 510 of filter vessel 500. The heavier liquid is removed with lower outlet 512 and the light liquid is removed by the top outlet 514.

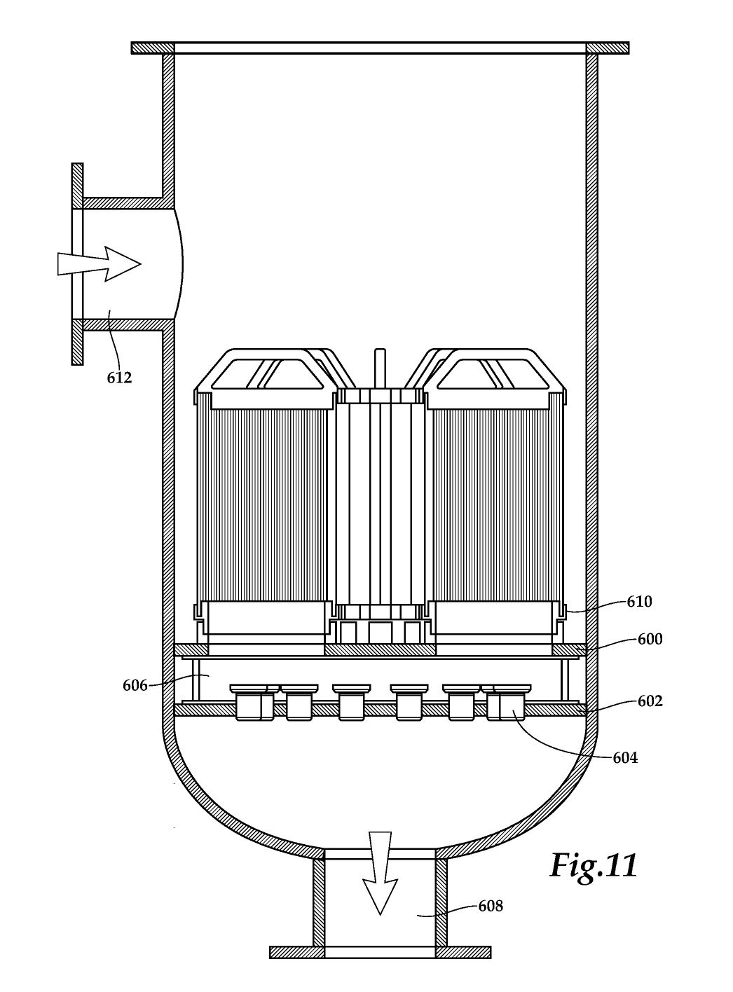

FIG. 11 is an illustration of a cylindrical housing that is used with multiple cylindrical filters internally that can be retrofitted to accommodate wedge shaped filter elements. FIG. 11 shows the retrofitted cylindrical filter vessel for the inside to outside flow as shown in prior figures including FIGS. 6A and 6B. The retrofitted separation plate 600 is installed in the filter vessel above the original separation plate 602. The fluid enters the vessel at inlet 612. The filtration process is the same, and the effluent from the voids inside of the wedge shaped filter elements flows though the openings in the bottom caps 610 into the openings in the retrofitted separation plate 600 and then into a chamber 606 above the original separation plate 602. The original separation plate 602 has multiple connectors 604 mounted thereon that were previously used with and correspond to the openings in the core of the multiple outside to inside cylindrical filters to collect effluent from the core of the cylindrical filters. The effluent in the retrofitted vessel will flow through the openings in connectors 604 and is collected at the bottom of the vessel and flows through outlet 608.

The wedge shaped filter elements can be arranged in multiple rows as shown in FIG. 12 if additional capacity is desired and the vessel size can accommodate multiple rows. The arrangement of multiple rows can be used for any process or method described herein.

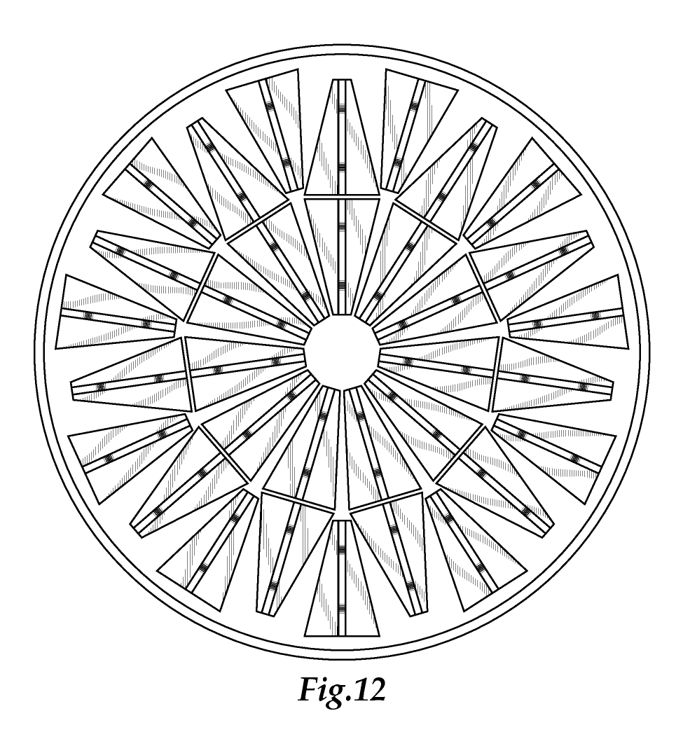

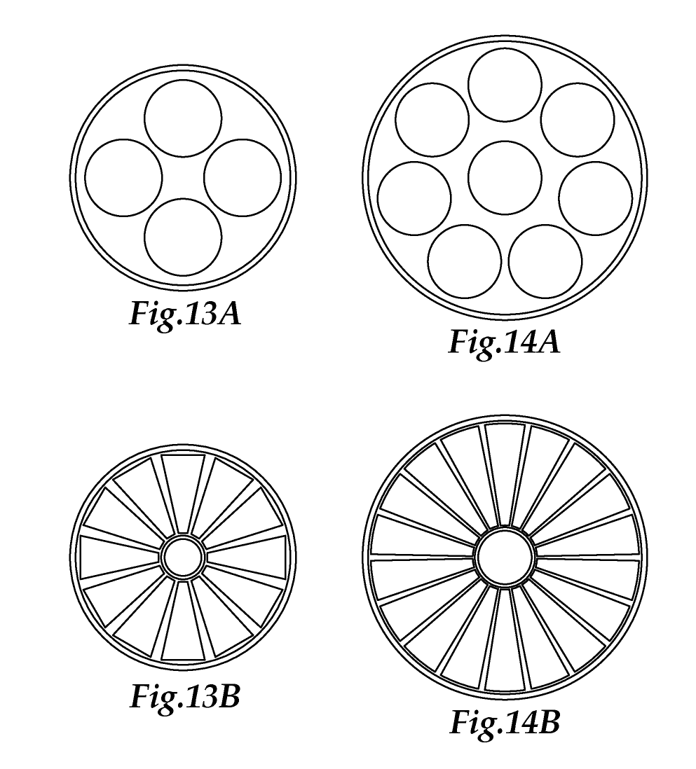

The efficiency of the disclosure has been tested using the wedge shaped filter elements for filtering solids from liquids. FIGS. 13 A and B illustrate an 18 inch outer diameter filter vessel with multiple cylindrical filter elements shown in FIG. 13A. An assembly of wedge shaped filter elements in an 18 inch outer diameter filter vessel is shown in FIG. 13B. FIGS. 14 A and B illustrate a 24 inch outer diameter filter vessel with multiple cylindrical filter elements shown in FIG. 14A. An assembly of wedge shaped filter elements in a 24 inch outer diameter filter vessel is shown in FIG. 13B. These drawings are illustrative of the filter placement in two conventional sized vessels and the same type of arrangement can be used in any size of vessel with wedge shaped filter elements sized to fit the vessel. Depending on the design, various number of the wedge filter elements can be provided inside the filter housing to increase the overall filter surface area. The life of the filter is longer due to the increase in the amount of fluid that can be filtered with the novel assembly and can be up to a 7.5 longer filter life. Also, due to the increased filtration efficiency a smaller vessel filled with the wedge shaped filters can be used to filter the same capacity as a larger vessel with cylindrical filters. The increased filter life and the possible use of a smaller vessel is a benefit for all embodiments of the invention. The spacing can be tight with enough flow between the elements for circulation of the fluid.

Table 1 compares various parameters for cellulose pleated media wedge shaped filters compared to cylindrical filters in filter vessels with typical diameters. The 18 inch and 24 inch vessels are illustrated in FIGS. 13 A, B and 14A, B respectively. The data is for cellulose pleated media, but natural media results are expected to be equivalent and have the same or similar benefits of cellulose. The wedge shaped filters are better in every regard including the number of filters contained in the vessel, the total filter media surface. The increase in media surface is proportional to the increase in filter efficiency.

Wedge vs Conventional Cylindrical Filter Cartridges
Natural Medias (e.g. Cellulose)

| | | | | | Surface area | Surface area |
|---|---|---|---|---|---|---|
| | Conventional | Conventional | | | (ft²) increase | (ft²) increase |
| | Cylindrical | Cylindrical | | Wedge Filter | Wedge Filter vs | Wedge Filter vs |
| | Filters Cartridge | Filter Cartridge | Wedge Filters | Surface Area | Conventional | Conventional |
| Vessel | per Vessel | Surface Area | per Vessel | per Vessel | Cylindrical Filter | Cylindrical Filter |
| Diameter (″) | Diameter (#) | (ft²) | Diameter (#) | Diameter (ft²) | by percentage (%) | by multiple (x) |
| 18 | 4 | 272 | 12 | 603 | 122% | 2.22x |
| 24 | 8 | 544 | 18 | 1519 | 179% | 2.79x |

The same data is presented in Table 2 for pleated polypropylene media. The same or similar results can be expected for other synthetic media.

Wedge vs Conventional Cylindrical Filter Cartridges
Synthetic or Other Medias (e.g. Polypropylene, Polyester, Glass Fiber, Nylon, PVDF, PTFE, PPS, etc)

| | | | | | | Increase in |
|---|---|---|---|---|---|---|
| | Conventional | Conventional | | | % increase in | Surface area of |
| | Cylindrical | Cylindrical | | Wedge Filter | Surface area of | Wedge Filter vs |
| | Filters Cartridge | Filter Cartridge | Wedge Filters | Surface Area | Wedge Filter vs | Conventional |
| Vessel | per Vessel | Surface Area | per Vessel | per Vessel | Conventional | Cylindrical Filter |
| Diameter (″) | Diameter (#) | (ft²) | Diameter (#) | Diameter (ft²) | Cylindrical Filter (%) | by multiple (x) |
| 18 | 4 | 248 | 12 | 408 | 65% | 1.64x |
| 24 | 8 | 496 | 18 | 1027 | 107% | 2.07x |

A further embodiment of the invention is a method for filtering fluid outside in. The fluid to be filtered is introduced into cylindrical filter housing with a plurality of wedge shaped filters having top cap and bottom caps with pleated filter media extending from the wedged shaped top cap to the wedge shaped bottom cap with two rows of pleats gradually decreasing in size from larger to smaller pleats from the outer side of the wedge to the smaller inner side of the wedge with a layer of media connecting the outer most largest pleats to the smallest inner pleats providing a generally wedge central void inside the pleats. The wedge shaped filter elements are arranged in the circular manner inside the filter housing and the center can be opening or a central core. The fluid passes through a layer of pleated media and enters the void in the center of the wedge shaped filters wherein said void is closed at the top and bottom by the top cap and bottom cap. The bottom cap has an outlet for the filtered fluid. The filtered fluid is collected from the outlets on the bottom caps of the plurality of wedge shaped filters.

Another embodiment the invention is a method for filtering fluid inside to outside. The fluid to be filtered is introduced into cylindrical filter housing with a plurality of wedge shaped filters with the top caps mounted in a separation plate and the top caps having an opening. Pleated filter media is secured to the top cap and has two rows of pleats gradually decreasing in size from larger to smaller pleats from the outer side of the wedge to the smaller inner side of the wedge with a layer of media connecting the outer most largest pleats to the smallest inner pleats providing a generally wedge central void inside the pleats that communicates with the opening in the top cap. The wedge shaped filter element is arranged on the circular manner with shorter edge of the wedge toward the center and the larger see of the wedge to outer perimeter of the filer housing. The fluid passes through a layer of pleated media in the void in the center of the wedge shaped filters and flows out to the bottom of the filter vessel for collection. Basket may be mounted beneath the separation plate around the wedge shaped filter elements to maintain their integrity. The filtered fluid is collected from the bottom of the vessel.

Another embodiment is a method for removing liquid from a gas stream. A mixture of gas and liquid is introduced into a vessel. The gas and liquid mixture passes through a plurality of wedge shaped coalescers from inside to outside of the filter media. The gas is allowed to ascend to the top of the vessel. The liquid is allowed to settle at the bottom of the vessel. The gas is removed from the top of the vessel, while the liquid is removed from the bottom of the vessel. A similar method can be used for outside to inside flow using a plurality of wedge shaped coalescers.

A further embodiment of this disclosure is the method of separating liquids with different specific gravities. The first step in the preferred embodiment is introducing the liquid mixture into a vessel that is on a horizontal axis. The liquid mixture passes though one of a plurality of wedge shaped coalescers from inside to outside the filter media. The lighter filtered fluid floats to the top of the vessel and the heavier filtered fluid to sinks to the top of the vessel after filtration. The lighter fluid is collected from to the top of the vessel and the heavier fluid is collected from the bottom of the vessel. A similar method can be used for outside to inside flow using a plurality of wedge shaped coalescers.

An additional method of this disclosure is the liquid/ liquid separation utilizing the same method as the gas liquid separation described above with a vessel that is upright rather than horizontal.

Another method of this disclosure is the use of wedge shaped filter elements for a swimming pool or spa filter. The fluid to be filtered is introduced into cylindrical filter housing with a spider plate at the top of the filter housing. The water flows through a plurality of wedge shaped filters with pleated filter media extending from the spider cap at the top to the wedge shaped bottom cap with two rows of pleats gradually decreasing in size from larger to smaller pleats from the outer side of the wedge to the smaller inner side of the wedge with a layer of media connecting the outer most largest pleats to the smallest inner pleats providing a generally wedge central void inside the pleats. The wedge shaped filter elements are arranged in the circular manner inside the filter housing and the center can be opening or a central core. The fluid passes through a layer of pleated media and enters the void in the center of the wedge shaped filters wherein said void is closed at the top and bottom by the top cap and bottom cap. The bottom cap has an outlet for the filtered fluid. The filtered fluid is collected from the outlets on the bottom caps of the plurality of wedge shaped filters. The filtered fluid flows out of the filter housing and is returned to the pool or spa.

What is claimed is:

1. A three-dimensional wedge shaped filter element comprising
a) a solid top cap generally wedge shaped with side edges of approximately the same length connecting a longer and shorter end to form a wedge shape;
b) a bottom cap generally wedge shaped with side edges of approximately the same length connecting a longer and shorter end to form a wedge shape with a central outlet therein; and
c) pleated filter media extending from the wedged shaped top cap to the wedge shaped bottom cap with two rows of pleats gradually decreasing in size from larger to smaller pleats from the longer side of the wedge to the smaller side of the wedge with a layer of media connecting the outer most largest pleats and the smallest inner pleats providing a continuous layer of media with central void inside the pleats.

2. The three-dimensional wedge shaped filter element of claim 1, wherein the media is selected from the group of natural media, synthetic media, ceramic media, glass media and metal media.

3. The three-dimensional wedge shaped filter element of claim 1, further comprising a handle on the top cap.

4. A filter system comprising:
a) a filter housing;
b) a fluid inlet to the filter housing;
c) a separation plate secured to the inner circumference of the filter housing;
d) a plurality of wedge shaped filters enclosed in said filter housing in a generally circular arrangement with each of the wedge shaped filters having a central void surrounded by filter media, a solid top cap, a bottom cap with an opening located therein to communicate with the central void in the filter media that extends from the top cap to the bottom cap;
e) the bottom cap of each wedge shaped filter is mounted on the separation plate that is provided with openings to correspond to the openings in the bottom caps such that the fluid to be filtered passes through a layer of filter media into the central void of the wedge shaped filters and the filtered fluid passes through the opening in the separation plate; and
f) a chamber provided in the filter housing below the separation plate to collect the filtered clean fluid.

5. The filter system of claim 4, the filter housing further comprising a perforated support inside each of the central void of each filter element and said perforated supports are mounted on the circular separation plate.

6. The filter system of claim 4, further comprising a handle on the top cap of each of said wedge shaped filters.

7. The filter system of claim 4, wherein the media is selected from the group of natural media, synthetic media, ceramic media, glass media and metal media.

8. The filter system of claim 4, wherein the filter media is selected from the group of pleated or non-pleated media.

9. The filter assembly of claim 4, wherein the filter housing is generally cylindrical and the separation plate is generally circular mounted inside the housing.

10. The filter assembly of claim 4, additionally comprising
a) a spider cap placed above the wedge shaped filter elements inside a generally cylindrical filter housing with radiating arms from a central hub and arms generally contacting the top of each wedge shaped filter element; and
b) a mechanism to between the spider cap and the inside of the top of the housing to secure the spider plate over the wedge shaped filter elements when the filter housing is in use.

11. A three-dimensional wedge shaped filter element, comprising
a) a top cap generally wedge shaped with side edges of approximately the same length connecting a longer and shorter end to form a wedge shape with a central opening therein;
b) a bottom cap generally wedge shaped with side edges of approximately the same length connecting a longer and shorter end to form a wedge shape with a central outlet therein; and
c) pleated filter media extending from the wedged shaped top cap to the wedge shaped bottom cap with two rows of pleats gradually decreasing in size from larger to smaller pleats from the longer side of the wedge to the smaller side of the wedge with a layer of media connecting the outer most largest pleats and the smallest inner pleats providing a continuous layer of media with a generally wedge central void inside the pleats.

12. The three-dimensional wedge shaped filter element of claim 11, wherein the media is selected from the group of natural media, synthetic media, ceramic media, glass media and metal media.

13. The three-dimensional wedge shaped filter element of claim 11, further comprising a handle on the top cap.

14. A filter assembly comprising:
a) a filter housing;
b) a fluid inlet to the filter housing;
c) a plurality of wedge shaped filters enclosed in said filter housing, wherein each of said wedge shaped filters has a wedge shaped top cap with an opening, a wedge shaped solid bottom cap, filter media extending from under the top cap to the bottom cap with a central void that communicates with the opening in the top cap;
d) a separation plate spaced from the bottom of the filter housing to accommodate the length of the wedge shaped filters and sealably secured to the inner circumference of the filter housing in the filter assembly and is provided with wedge shaped openings to receive and secure in place the wedge shaped filters with the top caps extending above the separation plate;
e) the openings in said tops caps receiving the fluid to be filtered such that the fluid passes into the central void in the wedge shaped filter and through the media and into the filter housing below the separation plate;
f) the clean fluid is collected in the filter housing outside the wedge shaped filter elements below the separation plate in the filter housing; and
g) a clean fluid outlet from the filter housing beneath the separation plate.

15. The filter assembly of claim 14, wherein the filter housing is generally cylindrical and the separation plate is generally circular mounted inside the housing.

16. The filter assembly of claim 14, further comprising a handle on the top cap of each said wedge shaped filters.

17. The filter assembly of claim 14, wherein the filters are surrounded by baskets extending from the bottom of the separation plate and sized to receive the wedge shaped filters.

18. The filter assembly of claim 14, wherein the filter media is selected from the group of pleated and non-pleated media.

19. An assembly that can be operated with a long axis of a cylindrical filter housing placed horizontally to separate a mixture of heavy and light fluids assisted by gravity, comprising:
a) a housing;
b) a fluid inlet located on the filter housing;
c) a separation plate sealably secured to the inner circumference of the housing;
d) a plurality of wedge shaped coalescer elements arranged in a circular manner enclosed in said housing, wherein each of said wedge shaped coalescer elements has, a cap an opening communicating with the central void and the cap is mounted on the separation plate that has openings in communication with the cap openings, and a solid cap on the opposite end of the wedge shaped coalescer element from the end mounted in separation plate;
e) the fluid mixture to be separated passes into the housing through the openings in the separation plate and the cap mounted thereon into the central void of the wedge shaped coalescer elements and through the media;
f) the separated fluids are collected in the housing on the side opposite the separation plate;
g) the lighter fluid floats to the top of the housing and the heavier fluid settles to the bottom of the housing; and
h) the housing is provided with an outlet on the top to collect the lighter fluid and an outlet on the bottom to collect the heavier fluid.

20. An assembly for separation of a mixture of gas and liquids comprising:
a) a housing;
b) an inlet near the bottom of the housing for the introduction of a gas and liquid mixture
c) a separation plate sealably secured to the inner circumference of the housing;
d) a plurality of wedge shaped coalescer elements arranged in a circle manner inside the housing with a central void therein mounted above the separation plate;
e) a plurality of hollow risers mounted above the separation plate and below the wedge shaped coalescer elements with the void in communication with the hollow void in the riser;
f) openings in the separation plate to communicate with the hollow risers;
g) a liquid outlet in the housing above the separation plate; and
h) a gas outlet toward the top of the housing.

21. A method for filtering fluid, comprising:
a) introducing fluid to be filtered into a filter housing with a plurality of wedge shaped filters arranged in a circle manner;
b) filtering the fluid through a plurality of the wedge shaped filters by passing the fluid through filter media into a central void inside each wedge shaped filter;
c) collecting the filtered fluid from the central void of each wedge shaped filter in a separate chamber of the filter housing; and
d) removing the filtered fluid from the filter housing.

22. A method for filtering fluids comprising:
a) introducing fluid to be filtered into a filter housing with a plurality of wedge shaped filters arranged in a circle manner;
b) passing fluid into at least one of a central void located in each of the wedge shaped filters and further passing the fluid through a layer of media surrounding the void;
c) collecting the filtered fluid in a separate chamber of the filter housing; and
d) removing filtered fluid from the filter housing.

23. A method for removing gas from liquid comprising:
a) introducing a mixture of gas and liquid into a vessel;
b) passing the gas and liquid mixture through one of a plurality of wedge shaped filters arranged in a circle manner from a void inside the filter to outside of the filter media;
c) allowing the filtered gas to ascend to the top of the vessel;
d) allowing the liquid to accumulate at the bottom of the vessel;
e) removing the filter gas from the top of the vessel; and
f) removing the liquid from the bottom of the vessel.

24. A method for separating liquids with different specific gravities comprising:
a) introducing the liquid mixture into a vessel that is on a horizontal axis;
b) passing the liquid mixture through one of a plurality of wedge shaped coalescer elements arranged in a circle manner from a void inside the filter to outside of the media;
c) allowing the lighter filtered fluid to float to the top of the vessel;
d) allowing the heavier filtered fluid to sink to the top of the vessel;
e) collecting the lighter fluid from to the top of the vessel; and
f) collecting the heavier fluid from the bottom of the vessel.

25. The method for separating liquids with different specific gravities of claim 24, wherein the liquid mixture is introduced into a vertical vessel.
